(19) United States
(12) Patent Application Publication
(10) Pub. No.: US 2026/0127023 A1
(43) Pub. Date: May 7, 2026

(54) COMMAND STREAM STITCHING FOR HARDWARE ACCELERATION

(71) Applicants: Advanced Micro Devices, Inc., Santa Clara, CA (US); ATI Technologies ULC, Markham (CA); Xilinx, Inc., San Jose, CA (US)

(72) Inventors: Cheng Zhen, San Jose, CA (US); Sonal Santan, San Jose, CA (US); Min Ma, San Jose, CA (US); Pat Truong, Mississauga (CA); Satish Rangarajan, Bangalore (IN); Soren T. Soe, San Jose, CA (US); Yu Liu, Newark, CA (US)

(73) Assignees: Advanced Micro Devices, Inc., Santa Clara, CA (US); ATI Technologies ULC, Markham (CA); Xilinx, Inc., San Jose, CA (US)

(21) Appl. No.: 18/938,182

(22) Filed: Nov. 5, 2024

(51) Int. Cl. G06F 9/48; G06F 9/38; G06F 9/54

(52) U.S. Cl. CPC G06F 9/485; G06F 9/3802; G06F 9/542

(57) ABSTRACT

Command stream stitching for hardware acceleration includes generating, by a host processor, a stitched block representing a plurality of commands for a hardware accelerator. The host processor generates a stitched command from the plurality of commands. The stitched command references the stitched block. The hardware accelerator executes the stitched block in response to invoking the stitched command. The hardware accelerator generates a single notification directed to the host processor for the stitched command.

### TECHNICAL FIELD

This disclosure relates to hardware acceleration and, more particularly, to stitching together commands from an application for execution by a hardware accelerator.

### BACKGROUND

A hardware accelerator is a device or circuitry adapted to perform particular processing tasks. The processing tasks may be delegated from a host processor such as a Central Processing Unit (CPU). In many cases, the data set operated on by a hardware accelerator is too large to fit in the available memory of the hardware accelerator or too large to be processed in a single invocation of the hardware accelerator. As such, the data set and/or task to be performed must be broken into smaller parts for processing by the hardware accelerator. Such is often the case for Neural Processing Unit (NPU) type hardware accelerators that are adapted to perform a task such as an artificial intelligence (AI) based inferencing operation.

In the typical case, the inferencing operation is broken into many smaller parts that can be performed by the NPU. Each smaller part of the inferencing operation is initiated by way of a corresponding command. For example, the inferencing operation may be broken into hundreds or thousands of smaller operations each invoked by a corresponding command provided to the NPU. This approach also may be used when processing a data set through a plurality of different stages. Each stage may be broken down into smaller processing stages. Each smaller processing stage is initiated by a corresponding command.

These commands and corresponding operations traverse through the software and hardware layers of the host processor and the hardware accelerator. As may be observed, with this approach, the number of commands issued from the host processor to the hardware accelerator to perform even a single inferencing operation increases significantly. Each command has overhead in terms of command submission and completion. With respect to command submission, the command must be forwarded from the host processor to the hardware accelerator. In terms of command completion, for each command submitted to the NPU that is successfully executed, the NPU generates a notification to the host processor indicating that execution of the command has completed. This overhead for each command is fixed and usually time consuming. In some cases, the time required to execute a command by the NPU is less than the amount of time needed for command submission and completion.

### SUMMARY

In one or more embodiments, a method includes generating, by a host processor, a stitched block representing a plurality of commands for a hardware accelerator. The method includes generating, by the host processor, a stitched command from the plurality of commands. The stitched command references the stitched block. The method includes executing, by the hardware accelerator, the stitched block in response to invoking the stitched command. The method includes generating, by the hardware accelerator, a single notification directed to the host processor for the stitched command.

In one or more embodiments, a system includes a hardware accelerator and a host processor coupled to the hardware accelerator. The host processor is capable of implementing operations including generating a stitched block representing a plurality of commands for the hardware accelerator. The host processor is capable of implementing operations including generating a stitched command from the plurality of commands. The stitched command references the stitched block. The hardware accelerator is capable of implementing operations including executing the stitched block in response to invoking the stitched command. The hardware accelerator is capable of implementing operations including generating a single notification directed to the host processor for the stitched command.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments of the disclosed technology. The drawings, however, should not be construed to be limiting of the inventive arrangements to only the embodiments shown. Various aspects and advantages will become apparent upon review of the following detailed description and upon reference to the drawings.

FIG. 1 illustrates a computing environment in accordance with one or more embodiments of the disclosed technology.

FIG. 2 is a method of operation of the computing environment of FIG. 1 in accordance with one or more embodiments of the disclosed technology.

FIG. 3 illustrates a meta command implementation in accordance with one or more embodiments of the disclosed technology.

FIG. 4 illustrates a method of using meta commands in accordance with one or more embodiments of the disclosed technology.

FIG. 5 illustrates a fused command implementation in accordance with one or more embodiments of the disclosed technology.

FIG. 6 illustrates a method of using fused commands in accordance with one or more embodiments of the disclosed technology.

FIG. 7A illustrates chaining of commands in the case of a meta command in accordance with one or more embodiments of the disclosed technology.

FIG. 7B illustrates chaining of commands in the case of a fused command in accordance with one or more embodiments of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to hardware acceleration and, more particularly, to stitching together commands from an application for execution by a hardware accelerator. By stitching together commands, the hardware accelerator is capable of achieving improved performance such as faster execution while also providing greater flexibility. In accordance with the inventive arrangements described within this disclosure, methods, systems, and computer program products are provided that are capable of combining a plurality of commands into a stitched command that may be provided to a hardware accelerator. The stitched command effectively batches the plurality of commands for more efficient execution compared to providing the commands separately. Rather than incurring a fixed amount of overhead for each constituent command of the stitch command, the fixed overhead is incurred one time for the stitch command as a whole.

For purposes of illustration, the stitched command may include N commands, where N is an integer of two or more. The overhead in sending a command from a host processor to the hardware accelerator may be quantified in terms of an amount of time (T) that includes the sum of the amount of time required to forward the command from the host processor to the hardware accelerator and the amount of time for the hardware accelerator to notify the host processor that the command has been executed. Typically, the time T required for these communications is larger than the amount of time required for the hardware accelerator to execute the command itself. Accordingly, the overhead for executing N commands may be expressed as N*T. By comparison, the overhead for executing a stitched command formed from N commands is reduced to T.

The inventive arrangements may be used in cases where a large operator, or data set, must be broken down into smaller portions for processing by the hardware accelerator. The hardware accelerator, for example, may not have sufficient memory or other resources to load and/or process the entire operator or data set at one time. In breaking down such operations into many smaller commands, the communication overhead incurred between the host processor and the hardware accelerator may increase significantly. The inventive arrangements provide mechanisms for reducing the overhead and, as such, time required to process the large operator or data set.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

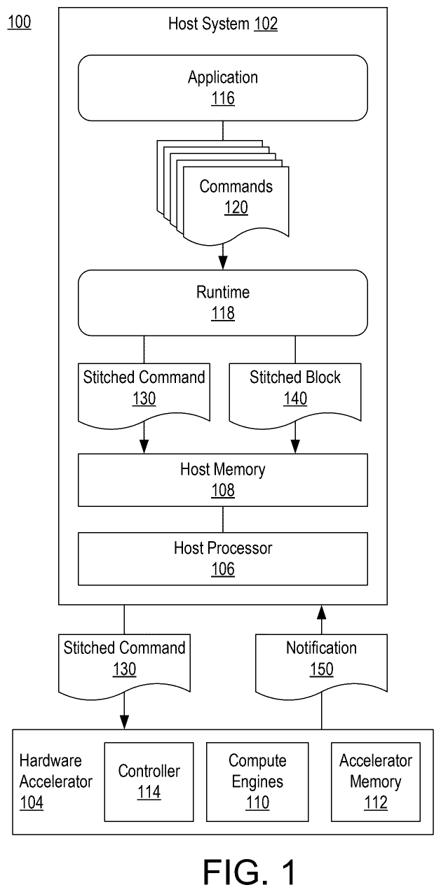

FIG. 1 illustrates a computing environment 100 in accordance with one or more embodiments of the disclosed technology. Computing environment 100 may include a host system 102 coupled to a hardware accelerator 104. Host system 102 includes a host processor 106 and a host memory 108. Hardware accelerator 104 includes one or more compute engines 110 and accelerator memory 112. Hardware accelerator 104 also may include a controller 114 that is capable of feeding commands to compute engines 110.

Host processor 106 may be implemented as one or more hardware processors. Host processor 106 may be implemented as one or more circuits capable of executing computer-readable program instructions (program instructions). The circuit(s) may comprise integrated circuits (ICs) or may be embedded within an IC. In one or more examples, host processor 106 may be embodied as a central processing unit (CPU). Host processor 106 may include one or more cores, for example, where each core is capable of executing computer-readable program instructions. Host processor 106 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

Host memory 108 may be embodied as one or more computer-readable storage mediums. In the example, host memory 108 may be implemented as a volatile memory. Host memory 108 may be referred to as a runtime memory. For example, host memory 108 may be a Random-Access Memory (RAM) such as a Double Data Rate (DDR) RAM. Host memory 108 also may include a non-volatile memory (not shown). Non-volatile memory may include a non-volatile magnetic medium and/or a solid-state medium (e.g., a “hard drive”).

Host memory 108 is capable of storing program instructions and/or data such that host processor 106 is capable of executing the program instructions to perform one or more operations as described within this disclosure. For example, the program instructions can include an application 116 and a runtime 118. Host memory 108 may also store an operating system, other program code, and program data (not shown).

Host processor 106 may be coupled to hardware accelerator 104 by way of an interface. Depending on the particular implementation of computing environment 100, host processor 106 may be coupled to hardware accelerator 104 via a communication bus, an interconnect, inter-die connections, or other circuitry and/or connections. For example, in one or more embodiments, computing environment 100 may be embodied in a single integrated circuit device whether implemented on a single die or as a multi-die IC device having a plurality of interconnected dies (e.g., chiplets). In one or more embodiments, computing environment 100 may be realized as a first IC device that is coupled to another IC device embodying hardware accelerator 104. In one or more embodiments, host system 102 may be embodied as a data processing system (e.g., a computer or server) and hardware accelerator 104 may be realized as a peripheral device of the data processing system.

Referring to hardware accelerator 104, compute engines 110 may be implemented as one or more circuits capable of performing computational operations. In one or more embodiments, compute engines 110 may be implemented as a data processing array where each compute engine is implemented as a data processing engine (e.g., a hardware processor). In one or more embodiments, compute engines 110 may implement a Neural Processing Unit capable of performing artificial intelligence and/or machine learning operations such as performing inference. Accelerator memory 112 may be implemented as RAM. In one or more embodiments, accelerator memory 112 may be implemented as Static RAM (SRAM). Controller 114 may be implemented as an Application-Specific IC block or as a hardware processor capable of executing instructions, a microcontroller, a state machine, or the like.

As noted, hardware accelerator 104 may be a device or circuitry designed or adapted to perform particular function(s) that may be delegated from host processor 106. Examples of hardware accelerator 104 may include, but are not limited to, a Graphics Processing Unit (GPU), a Neural Processing Unit (NPU), an IC that includes a processor array, a System-on-Chip (SoC), a programmable integrated circuit (IC) or the like. A programmable IC may be an IC that includes some programmable circuitry. Programmable logic is an example of programmable circuitry.

In the example of FIG. 1, runtime 118 is executed by host processor 106 to communicate with and control hardware accelerator 104. For purposes of illustration, application 116 may be capable of performing and/or invoking inference operations that are performed by hardware accelerator 104. For example, in operation, application 116 may subdivide an inference operation into a plurality of many smaller operations each corresponding to a command. For purposes of illustration, the inference operation may be broken down into N commands where N is an integer value of two or more. In practice, N may be an integer value that is significantly higher (e.g., where N is a value in the hundreds, thousands, or higher).

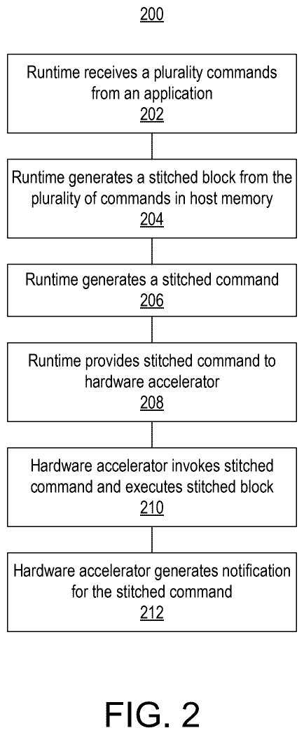

FIG. 2 is a method 200 of operation of computing environment 100 of FIG. 1 in accordance with one or more embodiments of the disclosed technology. Method 200 may begin in a state where host processor 106 is executing application 116 and runtime 118. Further, one or more or all of compute engines 110 have been allocated or reserved to perform operations delegated from host processor 106 and, more particularly, to execute commands originating from application 116.

As illustrated, application 116 is capable sending a plurality of commands 120 to runtime 118. In one or more embodiments, application 116 is capable of providing the plurality of commands 120 to runtime 118 by invoking an Application Programming Interface (API) of runtime 118. Accordingly, in block 202, runtime 118 receives the plurality of commands 120 from application 116. In block 204, runtime 118 is capable of generating a stitched block 140 from the plurality of commands 120 and storing stitched block 140 in host memory 108. In block 206, runtime 118 generates a stitched command 130. In block 208, runtime 118, provides stitched command 130 to hardware accelerator 104.

In the example, stitched block 140 represents the plurality of commands 120. For example, stitched block 140 may be implemented as a data structure representation of the plurality of commands 120. Stitched command 130 references stitched block 140 as stored in host memory 108. For example, stitched command 130 may be implemented as a data structure that points to stitched block 140 in host memory 108.

In block 208, runtime 118 is capable of providing stitched command 130 to hardware accelerator 104. For example, stitched command 130 may be stored in a queue in accelerator memory 112 and may be accessed by controller 114. In block 210, hardware accelerator 104 is capable of invoking stitched command 130. In response to invoking stitched command 130, hardware accelerator is capable of executing stitched block 140. For example, controller 114 is capable of invoking stitched command 130 thereby accessing stitched block 140 from host memory 108. Controller 114 is capable of fetching stitched block 140 to compute engines 110 for execution.

In block 212, hardware accelerator 104 is capable of generating a notification 150 for stitched command 130. Notification 150 is directed to host processor 106. Notification 150 may cause an interrupt in host processor 106. For example, controller 114 is capable of generating a single notification in response to completing execution of stitched block 140. Runtime 118 is capable of handling the interrupt initiated in response to notification 150.

In a conventional system implementation, each constituent command included in stitched block 140 would be forwarded from host processor 106 to hardware accelerator 104 sequentially. Subsequent to execution of each individual command, hardware accelerator 104 would generate a notification to host processor 106 (e.g., one notification for each individual command) indicating successful execution of that command. In this example, hardware accelerator 104 executes the commands represented by stitched block 140 sequentially. Hardware accelerator 104, or more particularly the set of compute engines 110 allocated to application 116, will not switch to process other commands, whether individual commands or other stitched commands, until processing of the commands represented by stitched block 140 and stitched command 130 is done. Further, in terms of indicating successful execution of commands, hardware accelerator 104 only generates notification 150 directed to host processor 106 indicating successful execution once all commands of stitch block 140 have been executed thereby reducing communication overhead between host processor 106 and hardware accelerator 104.

In one or more embodiments, in response to encountering an error in executing stitched block 140, hardware accelerator 104 is capable of generating notification 150 indicating that a command of stitched block 140 failed to execute or an error was encountered. The notification may specify information about the failed execution or error. Whether the interrupt generated by host processor 106 is a consequence of successful execution of stitched block 140 or an error (e.g., failed execution of stitched block 140), runtime 118 is capable of handling the interrupt initiated in response to notification 150.

In general, though the larger operator, e.g., an inference operation, is broken down into many different commands, groupings of the commands a represented by a stitched command 130 and stitched block 140 may be sent to hardware accelerator 104 and processed by hardware accelerator 104 as one single command atomically. Apart from the benefits of reducing communication overhead, there are instances where submitting commands one by one per conventional techniques means that compute engines 110 may sit idle for one or more clock cycles. This idle time is reduced using stitched command 130 and stitched block 140.

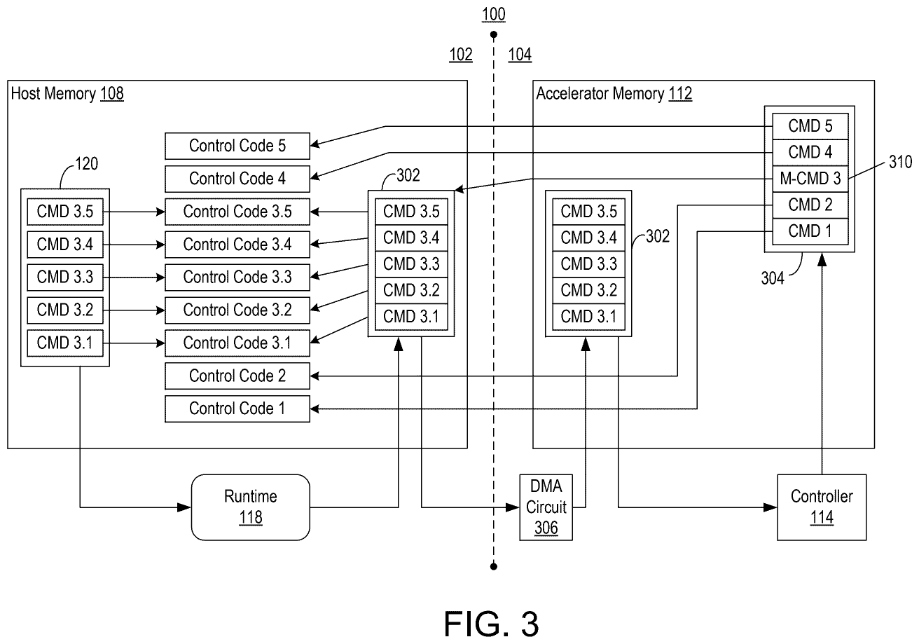

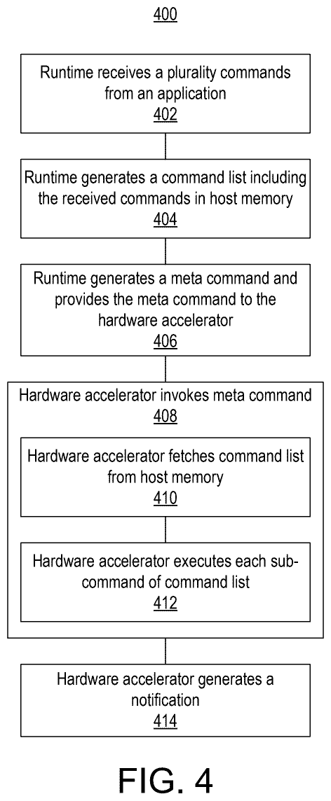

In one or more embodiments, stitched command 130 may be implemented as a meta stitched command (hereafter “meta command”). In that case, stitched block 140 may be implemented as a command list with the meta command referencing, or pointing, to the command list. The meta command is used to lower the overhead of command submission and completion. Meta commands are described in greater detail in connection with FIGS. 3 and 4.

FIG. 3 illustrates a meta command implementation in accordance with one or more embodiments of the disclosed technology. In one or more embodiments, the meta command implementation is a more particular example implementation of the embodiments described in connection with FIGS. 1 and 2.

FIG. 4 illustrates a method 400 of using meta commands in accordance with one or more embodiments of the disclosed technology. Referring to FIGS. 3 and 4 in combination, in block 402, runtime 118 receives a plurality of commands 120. As discussed, application 116 is capable of providing commands 120 to runtime 118. In the example of FIG. 3, commands 120 include commands 3.1, 3.2, 3.3, 3.4, and 3.5. For purposes of illustrating meta command implementation, the number of commands received may be two or more. In an actual implementation, a much larger number of commands may be received. In the example, after submitting command 3.5, application 116 may indicate to runtime 118 that no further commands will be sent, at least for the time being. As illustrated, each of commands 120 points to a corresponding control code that is also stored in host memory 108.

Control code refers to the items, e.g., data items, that are actually processed by hardware accelerator 104 and, more particularly, by compute engines 110. For example, the control code instructs firmware executed by hardware accelerator 104 where to find data to be processed and/or what operation is to be performed on the data. Each command (e.g., commands 1, 2, 3.1, 3.2, 3.3, 3.4, 3.5, 4, and 5 includes its own control code.

In block 404, runtime 118 places, or stores, commands 120 into a command list 302 that is stored within host memory 108 as a buffer. In one or more embodiments, runtime 118 is capable of concatenating the plurality of commands 120 to form command list 302. Command list 302 is accessible by hardware accelerator 104. In one or more embodiments, command list 302 is an example implementation of stitched block 140. As illustrated, each command of commands 120, as stored in command list 302, continues to point to its corresponding control code stored in host memory 108.

In block 406, runtime 118 generates a meta command 310 and provides meta command 310 to hardware accelerator 104. Meta command 310 has the address and size of command list 302. In the example of FIG. 3, meta command 310 is illustrated as “3” in a queue 304 in accelerator memory 112. Queue 304 also may be referred to a “mailbox.” As illustrated in the example of FIG. 3, meta command 310 points to command list 302 in host memory 108. Each command in command list 302 further points to a corresponding control code. In one or more embodiments, controller 114 is capable of receiving meta command 310 and placing meta command 310 in queue 304 in the order among other commands (e.g., 1, 2, 4, and 5) as received.

In block 408, controller 114 is capable of invoking meta command 310. Controller 114, in invoking meta command 310 detects that meta command 310 points to command list 302 stored in host memory 108. In this regard, meta command 310 is an example of an indirect command in that meta command 310 points to the particular commands that were concatenated into runtime list 302 (e.g., the plurality of commands 120). In this example, to execute runtime list 302, each of the commands therein still must be fetched by hardware accelerator 104.

In block 410, in response to invoking meta command 310, hardware accelerator 104 is capable of fetching command list 302 from host memory 108 and storing command list 302 (e.g., a copy thereof) in accelerator memory 112. For example, in response to invoking meta command 310, controller 114 is capable of detecting that meta command 310 points to command list 302 stored in host memory 108. Accordingly, in response to invoking meta command 310, controller 114 is capable of initiating a direct memory access (DMA) operation performed by a DMA circuit 306 of hardware accelerator 104. DMA circuit 306 copies command list 302 from host memory 108 to accelerator memory 112.

In block 412, hardware accelerator 104 executes each command included in command list 302 (e.g., as copied to accelerator memory 112). Controller 114 is capable of executing each command 3.1, 3.2, 3.3, 3.4, and 3.5 in sequence. In general, hardware accelerator 104 starts iterating the list of commands from command list 302 and processes them one by one until all of the sub-commands are completed or one of the sub-commands fails.

In one or more embodiments, as each command still points to a corresponding control code stored in host memory 108, controller 114 may initiate a DMA data transfer to fetch the control code corresponding to each command of command list 302, as executed, from host memory 108 for execution by controller 114. Once fetched, controller 114 is capable of executing each control code to configure compute engines 110 in the same sequence as the commands are listed in command list 302. Controller 114 configures compute engines 110, for example, by programming DMA engines therein to move data into compute engines 110 and move data results out of compute engines 110, to load executable program code into particular compute engines, and the like.

In the example of FIG. 3, each access of a command (or in this case a meta command) in queue 304 may be referred to as a “mailbox invocation.” In the example, controller 114 is capable of executing all commands in command list 302 from a single mailbox invocation.

In block 414, hardware accelerator 104 is capable of generating notification 150 directed to host processor 106. Notification 150 indicates the status of execution of meta command 310 and, more particularly, whether each command of meta command 310 (e.g., each command of command list 302) successfully completed execution. The notification may be generated in response to meta command 310 successfully completing execution (e.g., error free) and indicate that status. The notification also may be generated in response to detecting a failure of meta command 310 to complete execution and indicate that status. For example, in response to any one of the commands of command list 302 failing to execute properly, notification 150 may be generated and indicate that status. In the case of a command of command list 302 failing, notification 150 may specify an index identifying the particular failed command and an error code.

Notification 150, as received by host processor 106, may trigger an interrupt. Runtime 118 is capable of reading notification 150. Runtime 118 is also capable of handling any interrupt triggered by notification 150, whether the interrupt indicates an error or a successful execution of meta command 310. In one or more embodiments, runtime 118 may log and/or output the notification and invoke one or more interrupt handling routines. Accordingly, host processor 106 and hardware accelerator 104 implement a handshake only one time in response to meta command 310 as opposed to implementing a handshake for each command constituent command of meta command 310. Further, in the example of FIGS. 3 and 4, while the commands are combined and the handshaking behavior is modified as discussed, compute engines 110 and controller 114 are still aware that multiple different commands are being executed sequentially.

In the example of FIG. 3, commands 1, 2, 3 (e.g., meta command 3), 4, and 5 may be written to the mailbox of accelerator memory 112, e.g., to queue 304. Commands 3.1, 3.2, 3.3, 3.4, and 3.5 of command list 302 (e.g., the commands combined to form the meta command) are fetched by way of DMA 306. Each of commands 1, 2, 3, 4, and 5, for example, may have the address of the corresponding control code for the command attached to or included as the payload of the command. Control codes also are fetched by DMA circuit 306.

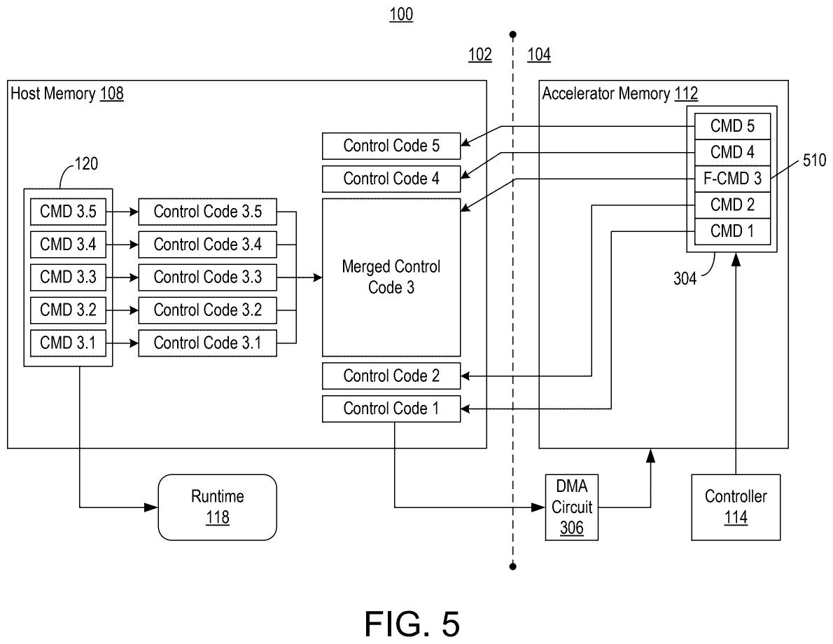

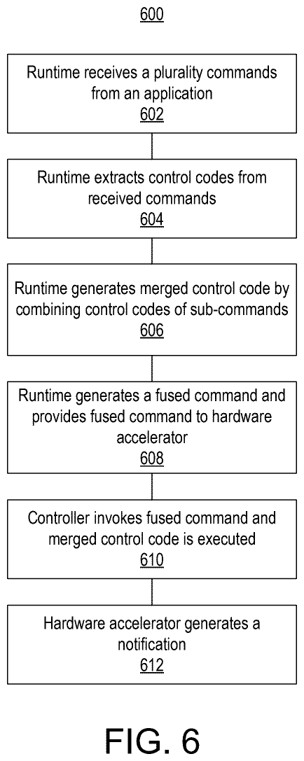

In one or more embodiments, stitched command 130 may be implemented as a fused stitched command (hereafter “fused command”). In the case of a fused command, multiple commands are combined such that compute engines 110 and controller 114 are unaware that more than one command is being executed. That is, compute engines 110 and controller 114 believe that a single command is being executed when executing the fused command. In the case of a fused command, stitched block 140 may be implemented as merged control code with the fused command referencing, or pointing, to the merged control code. Fused commands are described in greater detail in connection with FIGS. 5 and 6.

FIG. 5 illustrates a fused command implementation in accordance with one or more embodiments of the disclosed technology. In one or more embodiments, the fused command implementation is a more particular example implementation of the embodiments described in connection with FIGS. 1 and 2.

FIG. 6 illustrates a method 600 of using fused commands in accordance with one or more embodiments of the disclosed technology. Referring to FIGS. 5 and 6 in combination, in block 602, runtime 118 receives a plurality of commands 120. As discussed, application 116 is capable of providing commands 120 to runtime 118. In the example of FIG. 5, commands 120 include commands 3.1, 3.2, 3.3, 3.4, and 3.5. For purposes of illustrating fused command implementation, the number of commands received may be two or more. In an actual implementation, a much larger number of commands may be received. In the example, after submitting command 3.5, application 116 may indicate to runtime 118 that no further commands will be sent, at least for the time being. As illustrated, each of commands 120 points to a corresponding control code that is also stored in host memory 108.

In block 604, runtime 118 is capable of extracting the control code from each of the commands received in block 602. Runtime 118 is capable of extracting control code 3.1, control code 3.2, control code 3.3, control code 3.4, and control code 3.5 from command 3.1, command 3.2, command 3.3, command 3.4, and command 3.5, respectively. For example, for each command that is to be used in creating a stitched command, runtime 118 obtains the control code pointed to by the address of the payload of that command.

In block 606, runtime 118 is capable of combining (e.g., merging, or stitching) the control codes extracted in block 604 to form merged control code. In one or more embodiments, the control codes are concatenated by runtime 118. For example, runtime 118 is capable of combining control code 3.1, control code 3.2, control code 3.3, control code 3.4, and control code 3.5 into a merged control code 3 stored in host memory 108. In one or more embodiments, merged control code 3 is an example implementation of stitched block 140. Merged control code 3, as executed by hardware accelerator 104, appears or is interpreted as a single command. Whereas the stitched block from FIGS. 3 and 4 combines multiple commands, at the control code level, hardware accelerator 104 still is aware that multiple commands are being executed as each control code is independently fetched and submitted for execution. In this example, the merged control code (e.g., merged control code 3 in this example) is submitted to hardware accelerator 104 and executed as a single, larger command.

In one or more embodiments, runtime 118 is capable of adding one or more control code(s) within the merged control code to fuse, glue, or connect the different portions of control code together.

For example, in some cases, runtime 118 inserts one or more NOOP (no operation) instructions between control codes of merged control code 3. The NOOP instructions may be used to synchronize operation of various ones of compute engines 110 during runtime.

In some cases, runtime 118 inserts a “LOAD_PDI” op code between control codes of merged control code 3. The “LOAD_PDI” opcode instructs hardware accelerator 104 to switch to a different programming device image (PDI) that loads a different configuration/program code into compute engines 110 to perform a next/different set of tasks specified by a next control code sequence of merged control code 3. Certain instructions such as the “LOAD_PDI” opcode may have been provided between individual control codes. Due to merging the control codes, the firmware executed by hardware accelerator 104 no longer sees individual commands. This means that any actions that would have otherwise been performed between commands must be inserted into the merged control code 3 to ensure that the compute engines 110 are properly configured to execute a given sequence of control codes. Inserted control codes, for example, may indicate to the firmware executed by hardware accelerator 104 that one processing phase has completed and another is starting.

Example 1 below illustrates a portion of example control code.

Example 1

REGISTER_WRITE <address> <value>
REGISTER_WRITE <address> <value>
REGISTER_POLL <address> <value>

Example 2 below illustrates the portion of control code from Example 1 fused with another portion of control code. In the example, the two portions are fused together and joined by the LOAD_PDI control code.

Example 2

REGISTER_WRITE <address> <value>
REGISTER_WRITE <address> <value>
REGISTER_POLL <address> <value>
LOAD_PDI <address>
REGISTER_WRITE <address> <value>
REGISTER_WRITE <address> <value>
REGISTER_POLL <address> <value>

In one or more embodiments, as part of block 606, runtime 118 is capable of patching one or more addresses of various data items of the control codes corresponding to commands 3.1, 3.2, 3.3, 3.4, and 3.5. For example, runtime 118 may need to patch (e.g., modify or update) some of the control code instructions with new offset(s) due to the new position of the control code within merged control code 3. As an example, runtime 118 may need to patch addresses of data items such as input(s), output(s), and weights within control code 3.1, control code 3.2, control code 3.3, control code 3.4, and control code 3.5 due to the merging of the respective control codes.

In block 608, runtime 118 is capable of generating a fused command 510 and providing fused command 510 to hardware accelerator 104. Unlike the meta command, fused command is a direct command in that fused command 510 points directly to control code and, more particularly, merged control code 3. Fused command 510 may be a single inferencing command that initiates execution of the merged control code.

In the example of FIG. 5, fused command 510 is illustrated as “3” in queue 304 in accelerator memory 112. Queue 304 also may be referred to a “mailbox.” As illustrated in the example of FIG. 5, fused command 510 points to merged control code 3 in host memory 108. In one or more embodiments, controller 114 is capable of receiving fused command 510 and placing fused command 510 in queue 304 in the order received.

In block 610, controller 114 is capable of invoking fused command 510. Controller 114, in invoking fused command 510, fetches merged control code 3 from host memory 108 and executes merged control code 3. In one or more embodiments, in response to invoking fused command 510, controller 114 is capable of initiating a DMA operation performed by a DMA circuit 306 of hardware accelerator 104. DMA circuit 306 copies merged control code 3 from host memory 108 to accelerator memory 112. Controller 114 is capable of submitting merged control code 3 to compute engines 110 as a single, larger control code for execution.

In the example of FIGS. 5 and 6, each access of a command (or in this case a fused command) in queue 304 may be referred to as a “mailbox invocation.” In the example, controller 114 is capable of executing merged control code 3 in its entirety from a single mailbox invocation.

In block 612, hardware accelerator 104 is capable of generating notification 150 directed to host processor 106. Notification 150 indicates the status of execution of the merged control code (merged control code 3 in this example). Notification 150 may be generated in response to merged control code 3 successfully completing execution (e.g., error free) and indicate that status. Notification 150 also may be generated in response to detecting a failure of merged control code 3 to execute or complete execution and indicate that status. In the case of an error, notification 150 may specify information such as an error code and identifying information of the particular control code that caused the error. For example, as part of notification 150, the position of the failed control code instruction within merged control code 3 may be specified along with the error code.

Notification 150, as received by host processor 106, may trigger an interrupt. Runtime 118 is capable of reading notification 150. Runtime 118 is also capable of handling any interrupt triggered by notification 150, whether the interrupt indicates an error or a successful execution of merged control code 3. In the case of an error indicated by notification 150, runtime 118 is capable of mapping the failed control code instruction in merged control code 3 to the original command from which that control code was extracted. For example, if execution of control code 3.2 within merged control code 3 caused an error, that control code may be mapped to command 3.2. In one or more embodiments, runtime 118 may log and/or output the notification and invoke one or more interrupt handling routines.

In the example of FIG. 5, commands 1, 2, 3 (e.g., fused command 3), 4, and 5 may be written to the mailbox of accelerator memory 112, e.g., queue 304. As noted, each of commands 1, 2, 3, 4, and 5, for example, may have the address of the corresponding control code for the command attached to or included as the payload of the command. Control codes also are fetched by DMA circuit 306.

Accordingly, host processor 106 and hardware accelerator 104 implement a handshake only one time in response to executing merged control code 3 (as opposed to handshaking after execution of each command used to generate control code 3). The process is further streamlined over the example of FIGS. 3 and 4 in that multiple control codes (e.g., merged control code 3) is provided to hardware accelerator in response to invoking fused command 510 rather than still executing each command of command list 302 and fetching each control code individually. This further reduces latency from the example of FIGS. 3 and 4.

Another benefit of the fused command implementation over conventional techniques and even the meta command implementation is that runtime 118 may be capable of applying certain optimizations to further streamline the merged control code. This process may be performed across the boundaries of the individual control codes corresponding to different commands due to the merging. That is, the optimization may be performed across the control codes of a plurality of different commands that are being combined into a single merged control code. Such optimizations may not be possible in the case of the meta commands.

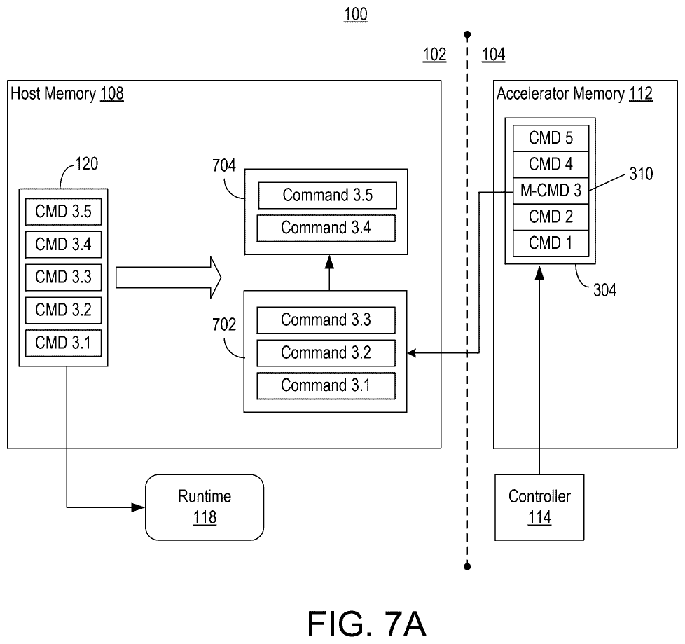

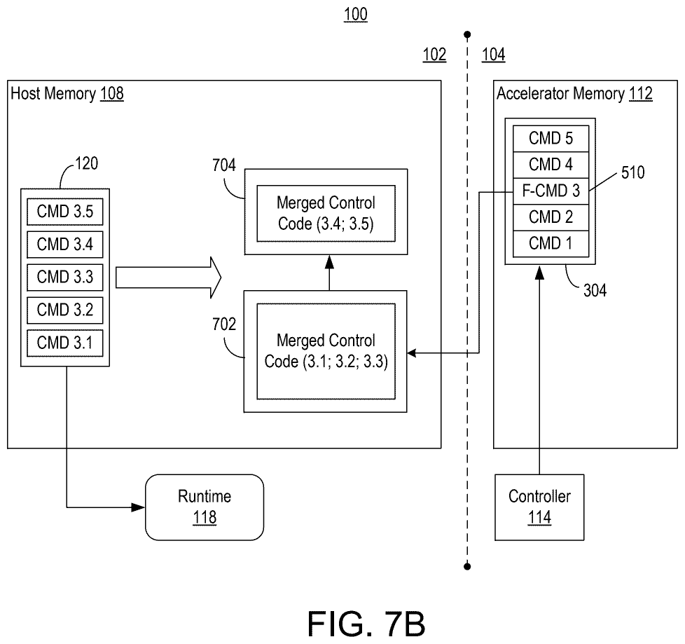

FIGS. 7A and 7B illustrate chaining of commands in accordance with one or more embodiments of the disclosed technology. Different hardware accelerators may have different processing capabilities due to hardware resource limitations or runtime resource limitations. There may be too many commands included to form either a meta command or a fused command. In such cases, the stitched command itself may be too large for the hardware accelerator to fetch and process. With the stitched command being too large, it logically follows that the data to be processed also would be too large for the hardware accelerator to process.

Such limitations may be addressed by creating sub-lists of commands and chaining, or linking, the sub-lists of commands together. By doing so, the limitations of the hardware may be overcome via upper layer software such as runtime 118. In one or more embodiments, runtime 118 is capable of breaking up, or subdividing, command list 302 into two or more sub-lists for the hardware accelerator to process. For example, runtime 118 may include a parameter specifying a threshold. The threshold specifies a maximum number of commands that may be accepted into a stitched command or a maximum size of the stitched command (whether for formation of a meta command or a fused command). Runtime 118 may subdivide the command list 302 into sub-lists of commands such that each individual sub-list does not exceed the threshold.

FIG. 7A illustrates chaining of commands in the case of a meta command in accordance with one or more embodiments of the disclosed technology. In the example, runtime 118 has formed sub-list 702 and sub-list 704. Each sub-list includes a plurality of commands in a number or size so as not to exceed the threshold. Further, runtime 118 marks sub-list 702 as “chained” while sub-list 704 is not marked as chained (e.g., is marked as the end of the chain). This marking informs hardware accelerator 104 to not send a notification until a sub-list that is not marked as chained has completed processing. Appreciably, the error processing still may be implemented in the case where a command fails to execute.

In the example, hardware accelerator 104 will execute meta command 310, which causes hardware accelerator 104 to execute sub-list 702 including commands 3.1, 3.2, and 3.3. Because sub-list 702 is marked as “chained,” hardware accelerator 104 then executes sub-list 704 including commands 3.4 and 3.5. Only upon completion of execution of each command in sub-list 704, which is not marked as chained or is marked as the end of the chain, will hardware accelerator 104 send a notification presuming no error was encountered.

FIG. 7B illustrates chaining of commands in the case of a fused command in accordance with one or more embodiments of the disclosed technology. In the example, runtime 118 has formed sub-list 702 and sub-list 704. Each sub-list includes a merged control code including the control codes for a plurality of commands so as not to exceed the threshold whether in terms of number of commands or size. Further, runtime 118 marks sub-list 702 as “chained” while sub-list 704 is not marked as chained (e.g., marked as the end of the chain). This marking informs hardware accelerator 104 to not send a notification until a sub-list that is not marked as chained has completed processing. Appreciably, the error processing still may be implemented in the case where a command fails to execute.

In the example, hardware accelerator 104 will execute fused command 510, which causes hardware accelerator 104 to execute sub-list 702 including merged control code including the control codes extracted from commands 3.1, 3.2, and 3.3. Because sub-list 702 is marked as “chained,” hardware accelerator 104 then executes sub-list 704 including merged control codes including the control codes extracted from commands 3.4 and 3.5. Only upon completion of execution of the merged control code of sub-list 704 will hardware accelerator 104 send a notification presuming no error was encountered.

The chaining illustrated in the examples of FIGS. 7A and 7B provides runtime 118 with the ability to provide hardware accelerator 104 with what appears to be an unlimited number of commands. The “chained” designation, for example, will include a pointer to the next sub-list. With this implementation, a compiler executing in the host system is capable of executing in parallel with runtime 118. As hardware accelerator 104 executes the chained commands, runtime 118 is capable of continuing to add additional sub-lists to the chain that is formed. For example, while hardware accelerator 104 is executing sub-list 702, runtime 118 may continue adding command(s) and/or control code(s) as the case may be to sub-list 704 or adding a further or additional sub-list chained off of sub-list 704.

In a variety of different cases, a data processing system may execute one or more compilers that are building a model for execution. Chaining may be used in such cases. By continuing to grow or add to the chain corresponding to stitched command 130, such added sub-lists will be executed prior to hardware accelerator 104 continuing on to begin execution of command 4 in queue 304. Thus, the task referenced by stitched command 130 may continue to grow while hardware accelerator 104 is executing stitched command 130 despite command 4 already being queued.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums.

A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, “data processing system” means one or more hardware systems configured to process data, each hardware system including at least one hardware processor programmed to initiate operations and memory.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming language. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various embodiments of the disclosed technology have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by a host processor, a stitched block representing a plurality of commands for a hardware accelerator;
generating, by the host processor, a stitched command from the plurality of commands, wherein the stitched command references the stitched block;
executing, by the hardware accelerator, the stitched block in response to invoking the stitched command; and
generating, by the hardware accelerator, a single notification directed to the host processor for the stitched command.

2. The method of claim 1, wherein the stitched command is a meta command and the stitched block comprises the plurality of commands concatenated together as a command list stored in a host memory of the host processor.

3. The method of claim 2, wherein the executing the stitched block comprises:
fetching the command list from the host memory; and
executing, by the hardware accelerator, each command of the command list;
wherein each command of the command list points to a control code that is executable by the hardware accelerator.

4. The method of claim 2, wherein the hardware accelerator executes the stitched block as a plurality of individual commands.

5. The method of claim 1, wherein the stitched command is a fused command and the stitched block comprises merged control code including a control code extracted from each command of the plurality of commands.

6. The method of claim 5, wherein the generating the stitched block comprises:
extracting control codes from the plurality of commands; and
combining the control codes as extracted into the merged control code.

7. The method of claim 5, wherein the hardware accelerator executes the merged control code.

8. The method of claim 1, wherein the stitched block comprises a plurality of sub-lists that are linked.

9. The method of claim 8, wherein the host processor is capable of adding one or more additional sub-lists to the plurality of sub-lists while the hardware accelerator executes at least one of the plurality of sub-lists.

10. The method of claim 8, wherein each sub-list includes two or more commands for the hardware accelerator.

11. The method of claim 8, wherein each sub-list includes two or more control codes extracted from two or more commands for the hardware accelerator.

12. A system, comprising:
a hardware accelerator;
a host processor coupled to the hardware accelerator;
wherein the host processor is capable of implementing operations including:
generating a stitched block representing a plurality of commands for the hardware accelerator;
generating a stitched command from the plurality of commands, wherein the stitched command references the stitched block;
wherein the hardware accelerator is capable of implementing operations including:
executing the stitched block in response to invoking the stitched command; and
generating a single notification directed to the host processor for the stitched command.

13. The system of claim 12, wherein the stitched command is a meta command and the stitched block comprises the plurality of commands concatenated together as a command list stored in a host memory of the host processor.

14. The system of claim 13, wherein the executing the stitched block by the hardware accelerator comprises:
fetching the command list from the host memory; and
executing each command of the command list;
wherein each command of the command list points to a control code that is executable by the hardware accelerator.

15. The system of claim 13, wherein the hardware accelerator executes the stitched block as a plurality of individual commands.

16. The system of claim 12, wherein the stitched command is a fused command and the stitched block comprises merged control code including a control code extracted from each command of the plurality of commands.

17. The system of claim 16, wherein the generating the stitched block by the host processor comprises:
extracting control codes from the plurality of commands; and
combining the control codes as extracted into the merged control code.

18. The system of claim 16, wherein the hardware accelerator executes the merged control code.

19. The system of claim 12, wherein the stitched block comprises a plurality of sub-lists that are linked.

20. The system of claim 19, wherein the host processor is capable of adding one or more additional sub-lists to the plurality of sub-lists while the hardware accelerator executes at least one of the plurality of sub-lists.
